(19) United States
(12) Patent Application Publication
(10) Pub. No.: US 2015/0309439 A1
(43) Pub. Date: Oct. 29, 2015

(54) IMAGE-FORMING APPARATUS

(71) Applicants: KABUSHIKI KAISHA TOSHIBA, Tokyo (JP); TOSHIBA TEC KABUSHIKI KAISHA, Tokyo (JP)

(72) Inventors: Yoshihisa MASUDA, Yokohama Kanagawa (JP); Takeshi Endo, Sunto Shizuoka (JP)

(21) Appl. No.: 14/656,970

(22) Filed: Mar. 13, 2015

(30) Foreign Application Priority Data
Apr. 25, 2014 (JP) 2014-092023

(51) Int. Cl. G03G 15/04

(52) U.S. Cl. CPC G03G 15/04072

(57) ABSTRACT

In one embodiment, an image-forming apparatus includes an optical scanner. The optical scanner has an output-adjustment-handling unit and a connector. The connector is mounted on the board. The connector is below the output-adjustment-handling unit in the vertical direction where the optical scanner is mounted on the image-forming apparatus.

### CROSS-REFERENCE TO RELATED APPLICATION

This application is based upon and claims the benefit of priority from the prior Japanese Patent Application No. 2014-092023, filed on Apr. 25, 2014, the entire contents of which are incorporated herein by reference.

### FIELD

Embodiments relate generally to an image-forming apparatuses including an optical scanner.

### BACKGROUND

In the past, a laser board is fixed to an optical scanner of an image-forming apparatus. A laser diode, a laser driver, an output-adjustment-handling unit, a connector, and the like are mounted on the laser board. The connector is mounted on the above-mentioned laser board, and is above the laser diode, the laser driver, and the output-adjustment-handling unit in the vertical direction where the optical scanner is mounted on the image-forming apparatus. Further, the connector is mounted on the board, and is above adjustment-positions, at which the optical axis of the laser diode is adjusted or pitches of a plurality of beams from the laser-diode array are adjusted.

A harness is connected to the connector, and hangs down under the influence of gravity. The hanging harness hides the output-adjustment-handling unit and the optical-axis-adjustment-positions. Because the harness hides the output-adjustment-handling unit and the optical-axis-adjustment-positions, workability is lowered when a worker adjusts output and the optical axis. Further, when a worker assembles the optical scanner, he has to adjust the optical axis of the laser diode and a collimator lens, adjust the laser power, and the like. Further, such adjustment requires very precise processes. So a worker adjusts the optical axis and the laser power when the optical scanner is mounted on an adjusting apparatus, in which the posture of the optical scanner in this case is the same as the posture of the optical scanner mounted on the image-forming apparatus, such that deformation of the optical scanner under the influence of gravity does not affect adjustment. Meanwhile, because it is necessary for the laser diode to emit light during such adjustment, the above-mentioned laser board should be connected to a control board via a harness. In general, the control board is mounted below the optical scanner in order to easily attach/remove the optical scanner to/from the apparatus to be adjusted. In this situation, the hanging harness hinders adjustment of output and adjustment of the optical axis.

### BRIEF DESCRIPTION OF THE DRAWINGS

FIG. 1 is a cross-sectional view showing an image-forming apparatus of a first embodiment;

FIG. 2 is a perspective view showing an optical scanner of the image-forming apparatus of the first embodiment;

FIG. 3 is a perspective view showing a laser-driver board unit mounted on the optical scanner of the image-forming apparatus of the first embodiment;

FIG. 4 is a front view showing the laser-driver board unit mounted on the optical scanner of the image-forming apparatus of the first embodiment;

FIG. 5 is a diagram showing that signal lines are connected to a connector mounted on a board of the laser-driver board unit mounted on the optical scanner of the image-forming apparatus of the first embodiment; and

FIG. 6 is a diagram showing that the optical scanner of the image-forming apparatus of the first embodiment is being assembled and adjusted.

### DETAILED DESCRIPTION

According to one embodiment, an image-forming apparatus includes an image-forming unit and an optical scanner. The image-forming unit develops an electrostatic latent image formed on a photoreceptor so as to form a developer-image. The optical scanner irradiates the photoreceptor of the image-forming unit with light flux so as to form the electrostatic latent image. Further, the optical scanner includes a housing, a board, a light source, an output-adjustment-handling unit, and a connector. The board is mounted on the housing. The light source is connected to the board. The light source emits the light flux in a predetermined direction. The output-adjustment-handling unit is mounted on the board. The output-adjustment-handling unit adjusts output of the light flux emitted from the light source. The connector is mounted on the board. The connector is below the output-adjustment-handling unit in the vertical direction where the housing is mounted on the image-forming apparatus. The connector is connected to a signal line. The signal line transmits a control signal to the light source.

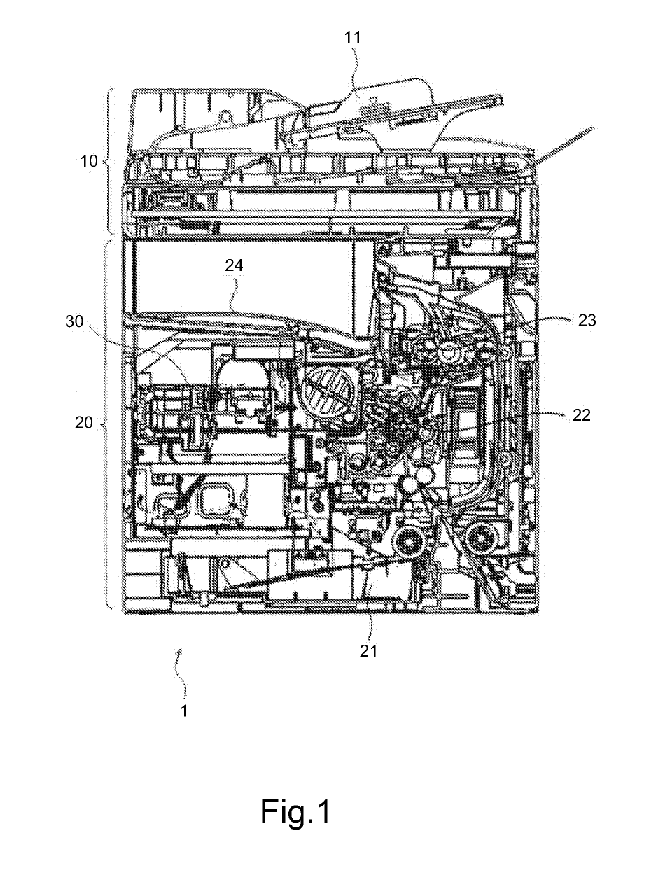

Hereinafter, further embodiment will be described with reference to the drawings. In the drawings, the same or similar components are denoted by the same reference numerals. An image-forming apparatus of a first embodiment will be described with reference to FIG. 1. FIG. 1 is a vertical cross-sectional view showing an image-forming apparatus of this embodiment. An image-forming apparatus 1 of FIG. 1 is, for example, an MFP (Multi Function Peripheral). As shown in FIG. 1, the image-forming apparatus 1 includes an image reader unit 10 and an image forming unit 20. The image reader unit 10 scans a sheet-document and a book-document, and thereby reads document images. The image forming unit 20 forms developer-images on a sheet based on the image data read by the image reader unit 10, image data sent from external equipment to the image-forming apparatus 1, and the like.

The image reader unit 10 includes an ADF (Automatic Document Feeder) 11. The image reader unit 10 reads images of document fed by the ADF 11 and images of documents on a document stage (not shown). The image forming unit 20 includes a sheet feeding cassette 21, an image-forming unit 22, a fuser 23, a discharge tray 24, and an optical scanner 30.

Hereinafter, how the image forming unit 20 behaves will be described.

The sheet feeding cassette 21 stores sheets. Pickup rollers and carrying rollers convey a sheet, which is stored in the sheet feeding cassette 21, to the image-forming unit 22. The image-forming unit 22 forms a developer-image on the sheet conveyed from the sheet feeding cassette 21. Specifically, the image-forming unit 22 includes a photoreceptor (not shown). The optical scanner 30 exposes the photoreceptor to laser light, i.e., light flux, and thereby forms an electrostatic latent image on the photosensitive surface of the photoreceptor.

After exposing the photoreceptor to light as described above, the image-forming unit 22 supplies developer to the photoreceptor, thereby develops the electrostatic latent image, and forms a developer-image on the photosensitive surface of the photoreceptor. When the developer-image is formed, the electrostatic latent image is visualized. After the electrostatic latent image is developed, the image-forming unit 22 transfers the developer-image, which is on the photoreceptor, to the sheet conveyed from the sheet feeding cassette 21. After transferring the developer-image, the image-forming unit 22 conveys the sheet, to which the developer-image has been transferred, to the fuser 23. The fuser 23 heats the developer-image, which has been transferred to the sheet, and thereby fixes the developer-image onto the sheet. After fixing the developer-image, the fuser 23 conveys the sheet to the discharge tray 24. The discharge tray 24 catches the sheet conveyed from the fuser 23, and next sheets are to be supplied on previous sheets.

FIG. 1 merely shows one example of the structure of the image-forming apparatus 1. The image-forming apparatus 1 may have any structure as long as it is capable of forming developer-images on a sheet.

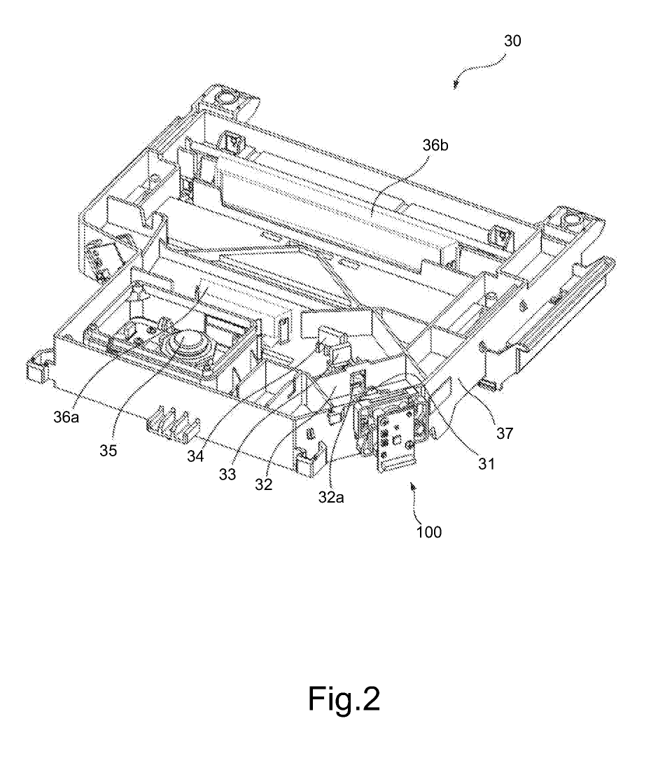

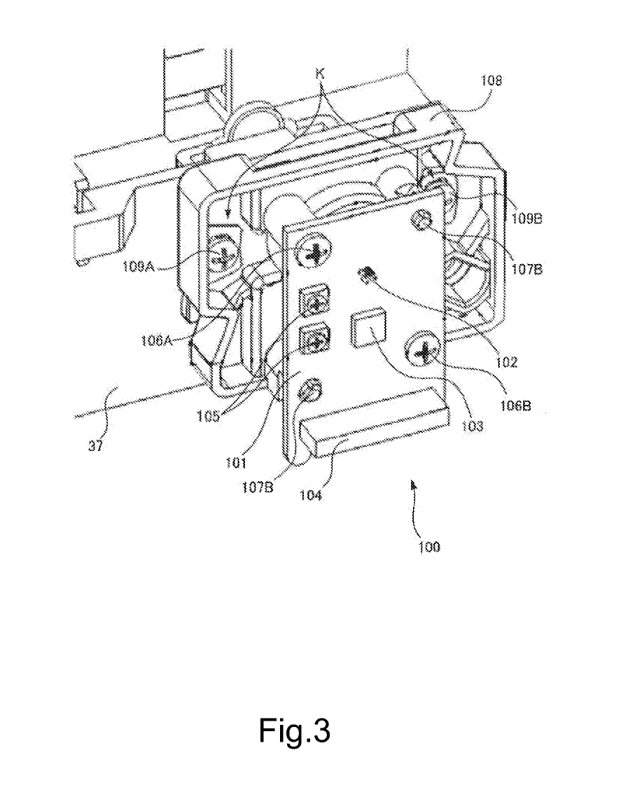

The optical scanner 30 will be described with reference to FIG. 2. FIG. 2 is a perspective view showing the optical scanner 30. The optical scanner 30 includes a housing 37. The housing 37 contains functional components (described later) of the optical scanner 30, such as a collimator lens 31. A board 101 of a laser-driver board unit 100 (described later) is mounted on the housing 37 (see FIG. 3). A laser diode 102 is a light source of the laser-driver board unit 100, and is mounted on the board 101. The laser diode 102 is fixed to the housing 37 by using a holder 108 (described later). The board 101 is used to drive the laser diode 102.

The optical scanner 30 further includes a collimator lens 31, a diaphragm plate 32, and a cylindrical lens 33. The collimator lens 31 receives laser light emitted from the laser diode 102. The laser light emitted from the laser diode 102 is diverging light. The collimator lens 31 receives the diverging laser light, and outputs substantially-parallel light. The collimator lens 31 is in the housing 37 of the optical scanner 30.

The laser light, which passed through the collimator lens 31, passes through the diaphragm plate 32. As shown in FIG. 2, the diaphragm plate 32 includes an opening 32a. The laser light from the collimator lens 31 passes through the opening 32a of the diaphragm plate 32. A plate may be punched out to form the diaphragm plate 32.

The diaphragm plate 32 is in the housing 37. Specifically the diaphragm plate 32 is mounted on the housing 37 such that the center of the opening 32a is on the optical axis. The diaphragm plate 32 blocks optical elements, which do not enter the opening 32a, out of the laser light from the collimator lens 31.

The laser light, which passed through the opening 32a of the diaphragm plate 32, enters the cylindrical lens 33. The cylindrical lens 33 converges the laser light from the diaphragm plate 32 in the vertical-scanning direction. The cylindrical lens 33 is in the housing 37.

The optical scanner 30 further includes a first mirror 34, a polygon mirror (which functions as a deflector) 35, and a the first fθ lens 36a, i.e., a first imaging lens. The laser light, which passed through the cylindrical lens 33 as described above, enters the first mirror 34. The first mirror 34 reflects the laser light, and the reflected laser light enters the polygon mirror 35. In other words, the laser light, which was emitted from the laser diode 102, reaches the polygon mirror 35. The polygon mirror 35 is in the housing 37, and is rotatable. The polygon mirror 35 reflects the laser light, which was reflected by the first mirror 34, and the reflected laser light enters the the first fθ lens 36a . The polygon mirror 35 rotates to thereby deflect the laser light, which was emitted from the laser diode 102, in the main-scanning direction.

The optical scanner 30 further includes a second fθ lens 36b, i.e., a second imaging lens. The laser light, which was reflected by the polygon mirror 35, enters the above-mentioned first fθ lens 36a, and then enters the second fθ lens 36b. The first fθ lens 36a and the second fθ lens 36b extend in the main-scanning direction. The first fθ lens 36a and the second fθ lens 36b converge the laser light, which was reflected by the polygon mirror 35, on a particular position on the photoreceptor. This position is a main-scanning-direction position, which is in proportion to the incident angle of the laser light entering the first fθ lens 36a. Further, the first fθ lens 36a and the second fθ lens 36b correct a displacement of the laser light, which results from inclination of the reflection surface of the polygon mirror 35.

For example, a second mirror, a third mirror, and a fourth mirror (not shown) reflect the laser light emitted from the second fθ lens 36b. After that, the reflected laser light passes through a dustproof glass plate (not shown), and enters the photoreceptor of the image-forming unit 22. When the photoreceptor of the image-forming unit 22 is irradiated with the laser light, an electrostatic latent image is formed on the photoreceptor, as described above. One example of the structure of the optical scanner 30 has been described above.

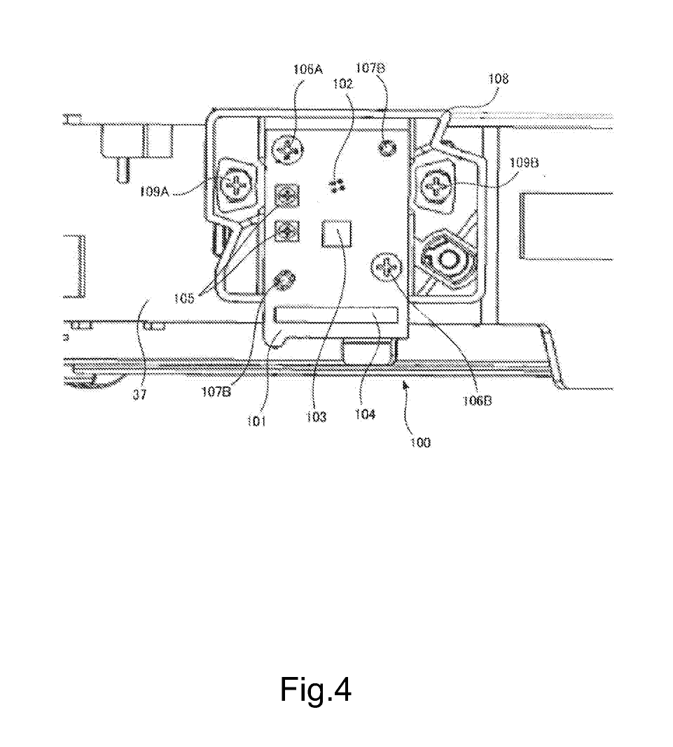

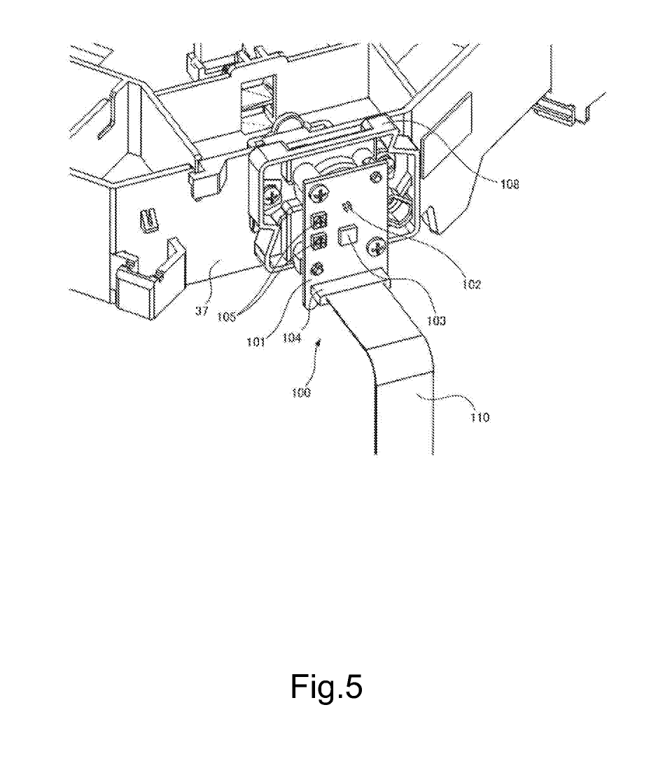

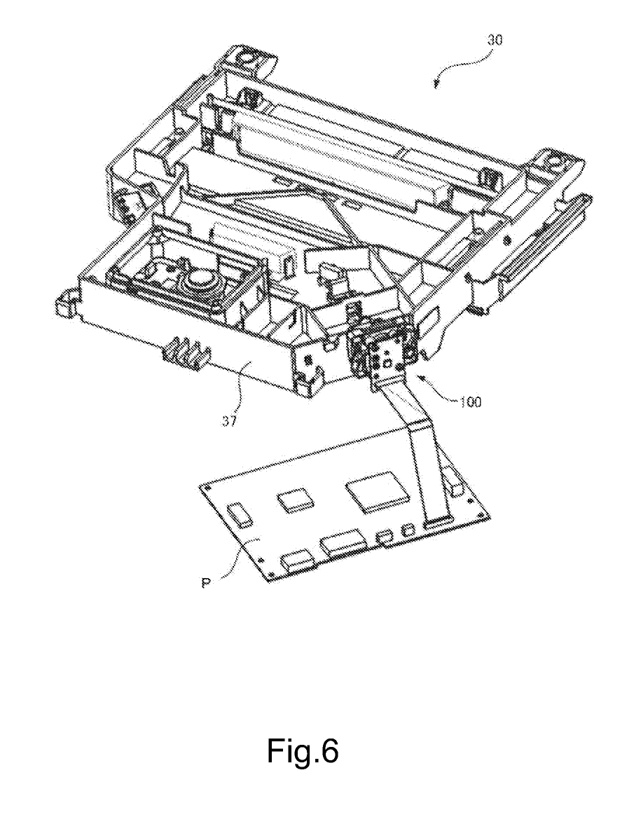

The optical scanner 30 includes the laser-driver board unit 100. Hereinafter, the laser-driver board unit 100 will be described with reference to FIG. 3, FIG. 4, FIG. 5, and FIG. 6. FIG. 3 is a perspective view showing the laser-driver board unit 100 of the optical scanner 30. FIG. 4 is a front view showing the laser-driver board unit 100 of the optical scanner 30. FIG. 5 is a diagram showing that signal lines 110 are connected to a connector 104 mounted on the board 101 of the laser-driver board unit 100. FIG. 6 is a diagram showing that the optical scanner 30 is being assembled and adjusted.

The laser-driver board unit 100 includes the board 101, the laser diode 102, a laser driver 103, the connector 104, and an output-adjustment-handling unit 105. In other words, the laser diode 102, the laser driver 103, the connector 104, and the output-adjustment-handling unit 105 are mounted on the board 101.

The laser diode 102 is a light source, and emits laser light to the collimator lens 31. The laser diode 102 emits laser light from the surface of the board 101, which is opposite to the surface on which the laser driver 103 is mounted (see FIG. 3), to the collimator lens 31. The laser diode 102 emits the laser light in response to a drive current from the laser driver 103.

The laser driver 103 controls output of laser light from the laser diode 102. The laser driver 103 is a chip, and outputs the drive current to drive the laser diode 102. The laser driver 103 receives a control signal via the connector 104, and causes the drive current to flow to the laser diode 102 in response to the control signal. The laser driver 103 is mounted on the board 101, and is below the laser diode 102 in the vertical direction where the housing 37 is mounted on the image-forming apparatus 1.

The connector 104 is mounted on the board 101. The signal lines 110 are connected to the connector 104 (see FIG. 5). The signal lines 110 are configured to transmit control signals to the laser driver 103. The control signals control the laser diode 102 to emit laser light. In this embodiment, the connector 104 is compatible with a flexible flat cable, and includes a plurality of connecting terminals. The flexible flat cable is generally referred to as FFC (Flexible Flat Cable), and includes a plurality of signal lines in parallel. The connector 104 is mounted on the board 101 such that the above-mentioned plurality of connecting terminals are arrayed in the horizontal direction where the housing 37 is mounted on the image-forming apparatus 1. Further, in this embodiment, the connector 104 is mounted on the board 101 such that the longitudinal direction of the connector 104 is substantially the same as the horizontal direction where the housing 37 is mounted on the image-forming apparatus 1. In general, a FFC cable has a mark such as a line. A worker is capable of visually confirming, based on this mark, if the FFC is upside down, inclined, inserted in the correct position of the connector, or not. Meanwhile, because of the above-mentioned arrangement of the connector 104, an assembly-worker, an assembly-inspector, or a maintenance-worker, who exchanges the optical scanner 30 in the field, is capable of confirming if the FFC cable is (signal lines 110 are) inserted in the connector 104 properly or not more easily.

The output-adjustment-handling unit 105 is capable of adjusting output of laser light emitted from the laser diode 102, and selecting a predetermined value of output (power) of laser light, with which the photoreceptor of the image-forming unit 22 is irradiated. In this embodiment, the output-adjustment-handling unit 105 includes screw portions, each of which has a screw shape. Each screw portion is capable of being rotated, and thereby adjusting output of laser light. In other words, the above-mentioned worker is capable of rotating the screw portions of the output-adjustment-handling unit 105 to thereby adjust output of laser light.

The laser diode 102 is mounted on the board 101, and the board 101 is mounted on the housing 37. For example, the board 101 is fixed to an external surface of the housing 37 such that the board surface is substantially vertical where the housing 37 is mounted on the image-forming apparatus 1. Further, the board 101 is fixed to the housing 37 by using the holder 108. Bosses 107A, 107B, i.e., positioning components, determine the position of the board 101. The board 101 has screw holes for fixing the board. Screws 106A, 106B for fixing the board are inserted in the screw holes for fixing the board. The distance on the board 101 between the connector 104 and one screw hole (hole for screw 106B) out of the screw holes for fixing the board is smaller than the distance on the board 101 between the connector 104 and each of the laser diode 102, the laser driver 103, and the output-adjustment-handling unit 105. In other words, the screw 106B is inserted in the screw hole for fixing the board, and fixes the board 101 to the housing 37 at there. The distance on the board 101 between the connector 104 and the screw 106B is smaller than the distance on the board 101 between the connector 104 and each of the laser diode 102, the laser driver 103, and the output-adjustment-handling unit 105. Because the screw 106B is close to the connector 104 and fixes the board 101 at there, it is possible to prevent a load from being applied to the board 101 when a worker or the like pulls out the signal lines 110 (see FIG. 5) connected to the connector 104 from the connector 104. By reducing a load applied to the board 101, it is also possible to prevent a load from being applied to the laser diode 102. To the contrary, if the screw 106B is distant from the connector 104 and fixes the board 101 to the holder 108 at there, the board 101 may bend and a load may be applied to the laser diode 102 when a worker or the like pulls out the signal lines 110 from the connector 104.

The laser diode 102 is mounted on the board 101, and the holder 108 holds the board 101. Specifically, the laser diode 102 is mounted on the board 101, and the board 101 is fixed to the holder 108. The holder 108 has screw holes for fixing the holder. Screws 109A, 109B for fixing the holder are inserted in the screw holes for fixing the holder. The screw holes for fixing the holder are formed above the connector 104 in the vertical direction where the housing 37 is mounted on the image-forming apparatus 1, and the board 101 is between the screw holes for fixing the holder. In other words, as shown in FIG. 3 and FIG. 4, the screws 109A, 109B are above the connector 104 in the vertical direction where the housing 37 is mounted on the image-forming apparatus 1, and the board 101 is between the screws 109A, 109B. The screws 109A, 109B fix the holder 108 to the housing 37 at there. Because the board 101, on which the laser diode 102 is mounted, is fixed to the holder 108 as described above, the optical axis of the laser light emitted from the laser diode 102 is adjusted by adjusting the position of the holder 108. The position of the holder 108 is adjusted by adjusting the above-mentioned screws 109A, 109B. For example, if the laser diode 102 is a laser-diode array having a plurality of light-emitting points, it is necessary to adjust pitches of beam spots, which are obtained by irradiating the photoreceptor with laser light emitted from the plurality of light-emitting points, in the vertical-scanning direction such that the pitches of the beam spots in the vertical-scanning direction are substantially the same as the resolution of the image-forming apparatus 1 in the vertical-scanning direction. The pitches of the beam spots are adjusted by adjusting inclination of rotation of the holder 108. In the following description, the positions, at which the screws 109A, 109B fix the holder 108 to the housing 37, will be referred to as optical-axis-adjustment-positions K (see FIG. 3).

The connector 104 is mounted on the board 101, and is below the laser driver 103 and the output-adjustment-handling unit 105 in the vertical direction where the housing 37 is mounted on the image-forming apparatus 1. When the connector 104 is mounted as described above, the signal lines 110, which are connected to the connector 104, hang down under the influence of gravity. Meanwhile, in this embodiment, the connector 104 is mounted below the output-adjustment-handling unit 105 and the optical-axis-adjustment-positions K. Because the connector 104 is arranged as described above, it is possible to prevent hanging signal lines 110 from hindering adjustment of output and adjustment of the optical axis.

In the past, the connector 104 is mounted above the output-adjustment-handling unit 105 and the optical-axis-adjustment-positions K on the board 101. Because of this, the signal line 110 hang down, and hide the output-adjustment-handling unit 105 and the optical-axis-adjustment-positions K. Because the signal line 110 hide the output-adjustment-handling unit 105 and the optical-axis-adjustment-positions K, workability is lowered when a worker adjusts output and the optical axis.

Further, as shown in FIG. 6, when a worker assembles and adjusts the image-forming apparatus 1, he connects the signal lines 110 and a control board P. Here, the signal lines 110 are connected to the connector 104, and the control board P is configured to output the above-mentioned control signal. In general, when assembling and adjusting the image-forming apparatus 1, the control board P is mounted below the connector 104 such that the control board P does not hinder attaching/removing of the optical scanner 30 to/from the image-forming apparatus 1. In this situation, the hanging signal lines 110 hinder adjustment of output of laser light and adjustment of the optical axis.

In this embodiment, the connector 104 is mounted below the laser driver 103 on the board 101 in the vertical direction where the housing 37 is mounted on the image-forming apparatus 1 (see FIG. 3 to FIG. 5). Further, the laser driver 103 is mounted on the board 101 below the laser diode 102. The connector 104 is connected to the laser driver 103 by wire. The laser driver 103 is connected to the laser diode 102 by wire. Since the functional components such as the laser diode 102 are connected to each other by wire as described above, the wiring pattern connecting the connector 104 and the laser driver 103 is shortened, and the wiring pattern connecting the laser driver 103 and the laser diode 102 is shortened. As a result, the current for driving the laser diode 102 is stabilized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image-forming apparatus, comprising:
an image-forming unit configured to develop an electrostatic latent image formed on a photoreceptor so as to form a developer-image; and
an optical scanner configured to irradiate the photoreceptor of the image-forming unit with light flux so as to form the electrostatic latent image, the optical scanner including
a housing,
a board mounted on the housing,
a light source, mounted on the board, which emits the light flux in a predetermined direction,
an output-adjustment-handling unit, mounted on the board, which adjusts output of the light flux emitted from the light source, and
a connector, mounted on the board below the output-adjustment-handling unit in the vertical direction where the housing is mounted on the image-forming apparatus, and connected to a signal line which transmits a control signal to the light source.

2. The image-forming apparatus according to claim 1, wherein
the optical scanner includes a holder which holds the board to mount the board on the housing.

3. The image-forming apparatus according to claim 2, wherein
the holder includes a screw hole in which a screw for fixing the holder, and
the screw for fixing the holder fixes the holder to the housing.

4. The image-forming apparatus according to claim 3, wherein
the screw hole for fixing the holder is formed above the connector in the vertical direction where the housing is mounted on the image-forming apparatus.

5. The image-forming apparatus according to claim 4, wherein
at least two screw holes for fixing the holder are provided, and
the screw holes for fixing the holder are formed such that the board is to be between the screw holes for fixing the holder where the housing is mounted on the image-forming apparatus.

6. The image-forming apparatus according to claim 5, wherein
at least two screws for fixing the holder are provided, and
the screws for fixing the holder fix the holder to the housing, the screws for fixing the holder being inserted in the screw holes for fixing the holder, respectively, the screws for fixing the holder being above the connector in the vertical direction where the housing is mounted on the image-forming apparatus, the board being between the screws for fixing the holder.

7. The image-forming apparatus according to claim 6, wherein
the optical axis of the light flux emitted from the light source is to be adjusted by adjusting the position of the holder by using the screws for fixing the holder.

8. The image-forming apparatus according to claim 7, wherein
the optical scanner includes a laser driver, the laser driver being configured to control output of the light source.

9. The image-forming apparatus according to claim 8, wherein
the connector is mounted on the board, the connector being below the laser driver in the vertical direction where the housing is mounted on the image-forming apparatus.

10. The image-forming apparatus according to claim 9, wherein
the laser driver is mounted on the board, the laser driver being below the light source in the vertical direction where the housing is mounted on the image-forming apparatus.

11. The image-forming apparatus according to claim 10, wherein
the board includes a screw hole for fixing the board, a screw for fixing the board being to be inserted in the screw hole for fixing the board, and
the screw for fixing the board fixes the board to the housing, the screw for fixing the board being inserted into the screw hole for fixing the board.

12. The image-forming apparatus according to claim 11, wherein
the connector includes a plurality of connecting terminals, and
the connector is mounted on the board such that the plurality of connecting terminals are arrayed in the horizontal direction where the housing is mounted on the image-forming apparatus.
